(19) United States
(12) Patent Application Publication
(10) Pub. No.: US 2008/0021702 A1
(43) Pub. Date: Jan. 24, 2008

(54) Wireless communication apparatus including a mechanism for suppressing uplink noise

(76) Inventors: Shaojie Chen, Austin, TX (US); Guner Arslan, Austin, TX (US)

Correspondence Address: NXP, B.V.;NXP INTELLECTUAL PROPERTY DEPARTMENT, M/S41-SJ, 1109 MCKAY DRIVE, SAN JOSE, CA, 95131, US

(21) Appl. No.: 11/477,014

(22) Filed: Jun. 28, 2006

(51) Int. Cl. G10L 19/00

(52) U.S. Cl. 704/201

(57) ABSTRACT

A wireless communication apparatus includes a voice encoder and uplink suppression logic. The voice encoder may be configured to encode a number of digital audio samples into voice payload data using one or more audio compression algorithms. The uplink suppression logic may be configured to provide an indication such as a flag, for example, of whether or not the voice payload data is ready for further processing. In addition, the uplink suppression logic may also be configured to cause one or more bad speech frames to be transmitted in response to the indication that the voice payload-data is not ready for further processing. For example, a bad speech frame may include a voice data block including the voice payload data and EDC that does not match the voice payload data.

### BACKGROUND OF THE INVENTION

1. Field of the Invention

This invention relates to wireless telephony and, more particularly, to suppressing noise caused by erroneous uplink data.

2. Description of the Related Art

Wireless communication devices such as mobile telephones, for example, that transmit and receive signals including speech audio typically include a voice or speech encoder/decoder or “vocoder.” The vocoder may be used for compression/decompression of digital voice audio using compression algorithms that may be designed specifically for audio applications. In addition, a channel encoder/decoder or channel codec may also be included to provide error protection of the received signal against channel imperfections. These two functions represent major functions in the physical layer of a cellular phone system. In many cases, these two functions are synchronized in time to ensure that valid encoded voice data is transmitted and received. However under certain conditions, these functions may become unsynchronized. When this occurs, undesirable voice payload data may be transmitted in the uplink. This undesirable voice payload data may be undetected as a bad speech frame at the receiver. As such, the data may be synthesized by the voice decoder and output to a user as a very uncomfortable noise.

### SUMMARY

Various embodiments of a wireless communication apparatus including a mechanism for suppressing noise resulting from uplink data. In one embodiment, the wireless communication apparatus includes a voice encoder and uplink suppression logic. The voice encoder may be configured to encode a number of digital audio samples into voice payload data using one or more audio compression algorithms. The uplink suppression logic may be configured to provide an indication such as a flag, for example, of whether the voice payload data is ready for further processing. In addition, the uplink suppression logic may also be configured to cause one or more bad voice data blocks to be generated for transmission in response to the indication indicating that the voice payload data is not ready for further processing.

In one specific implementation, the wireless communication apparatus includes an encoder control unit coupled to a channel encoder. In response to the indication that the voice payload data is not ready for further processing, the encoder control unit may be configured to cause the channel encoder to generate an error detection code that does not match the voice payload data. In addition, the control unit may also be configured to cause the channel encoder to create a voice data block including the voice payload data and the non-matching error detection code in response to the indication that the voice payload data is not ready for further processing.

In another specific implementation, in response to the indication that the voice payload data is not ready for further processing, the encoder control unit may be configured to cause the channel encoder to generate an error detection code based upon to the voice payload data, to modify the voice payload data such that it does not match the error correcting code, and to create a voice data block including the modified voice payload data and the error detection code.

In another embodiment, a method includes encoding a number of digital audio samples into voice payload data using one or more audio compression algorithms, providing an indication of whether the voice payload data is ready to be read, and in response to receiving the indication indicating that the voice payload data is not ready for further processing, generating one or more bad voice data blocks for transmission.

### BRIEF DESCRIPTION OF THE DRAWINGS

FIG. 1 is a generalized block diagram of one embodiment of a wireless communication apparatus.

FIG. 2 is a block diagram illustrating specific aspects of one embodiment of the digital processing circuit of FIG. 1.

FIG. 3 is a timing diagram illustrative of a typical multi-frame used in conjunction with one embodiment of the communication apparatus 100 of FIG. 1.

FIG. 4 is a block diagram illustrating more detailed aspects of the embodiment of the digital processing circuit of FIG. 2.

FIG. 5A is a flow diagram describing the operation of the embodiments of the voice encoder shown in FIG. 2 and FIG. 4.

FIG. 5B is a flow diagram describing the operation of the embodiments of the channel encoder shown in FIG. 2 and FIG. 4.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents, and alternatives falling within the spirit and scope of the present invention as defined by the appended claims. It is noted that the word “may” is used throughout this application in a permissive sense (i.e., having the potential to, being able to), not a mandatory sense (i.e., must).

### DETAILED DESCRIPTION

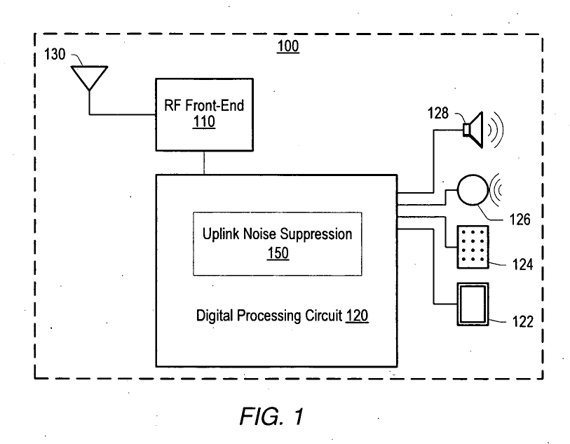

Turning now to FIG. 1, a generalized block diagram of a wireless communication apparatus 100 is shown. Wireless communication apparatus 100 includes an RF front-end circuit 110 coupled to a digital processing circuit 120. As shown, various user interfaces including a display 122, a keypad 124, a microphone 126, and a speaker 128 may be coupled to digital processing circuit 120, depending upon the specific application of wireless communication apparatus 100 and its desired functionality. An antenna 130 is also shown coupled to RF front-end circuit 110. It is noted that in various embodiments, wireless communication apparatus 100 may include additional components and/or couplings not shown in FIG. 1 and/or exclude one or more of the illustrated components, depending on the desired functionality. It is further noted that components that include a reference number and letter may be referred to by the reference number alone where appropriate, for simplicity.

Wireless communication apparatus 100 is illustrative of various wireless devices including, for example, mobile and cellular phone handsets, machine-to-machine (M2M) communication networks (e.g., wireless communications for vending machines), so-called “911 phones” (a mobile handset configured for calling the 911 emergency response service), as well as devices employed in emerging applications such as third generation (3G), fourth generation (4G), satellite communications, and the like. As such, wireless communication apparatus 100 may provide RF reception functionality, RF transmission functionality, or both (i.e., RF transceiver functionality).

Wireless communication apparatus 100 may be configured to implement one or more specific communication protocols or standards, as desired. For example, in various embodiments wireless communication apparatus 100 may employ a time-division multiple access (TDMA), a code division multiple access (CDMA) and/or a wideband CDMA (WCDMA) technique to implement standards such as the Global System for Mobile Communications (GSM) standard, the Personal Communications Service (PCS) standard, and the Digital Cellular System (DCS) standard, for example. In addition, many data transfer standards that work cooperatively with the various technology platforms may also be supported. For example, wireless communication apparatus 100 may also implement the General Packet Radio Service (GPRS) standard, the Enhanced Data for GSM Evolution (EDGE) standard, which may include Enhanced General Packet Radio Service standard (E-GPRS) and Enhanced Circuit Switched Data (ESCD), the high speed circuit switched data (HSCSD) standard, high speed downlink packet access (HSDPA), high speed uplink packet access (HSUPA), and evolution data optimized (EV-DO), among others.

RF front-end circuit 110 may accordingly include circuitry to provide RF reception capability and/or RF transmission capability. In one embodiment, front-end circuit 110 may down-convert a received RF signal to baseband and/or up-convert a baseband signal for RF transmission. RF front-end circuit 110 may employ any of a variety of architectures and circuit configurations, such as, for example, low-IF receiver circuitry, direct-conversion receiver circuitry, direct up-conversion transmitter circuitry, and/or offset-phase locked loop (OPLL) transmitter circuitry, as desired. RF front-end circuit 110 may additionally employ a low noise amplifier (LNA) for amplifying an RF signal received at antenna 130 and/or a power amplifier for amplifying a signal to be transmitted from antenna 130. In alternative embodiments, the power amplifier may be provided external to RF front-end circuit 1 10.

Digital processing circuit 120 may provide a variety of signal processing functions, as desired, including baseband functionality. For example, digital processing circuit 120 may be configured to perform filtering, decimation, modulation, demodulation, coding, decoding, correlation and/or signal scaling. In addition, digital processing circuit 120 may perform other digital processing functions, such as implementation of the communication protocol stack, control of audio testing, and/or control of user 1/0 operations and applications. To perform such functionality, digital processing circuit 120 may include various specific circuitry, such as a software programmable microcontroller (MCU) and/or digital signal processor (DSP) (not shown), as well as a variety of specific peripheral circuits such as memory controllers, direct memory access (DMA) controllers, hardware accelerators, voice coder-decoders (CODECs), digital audio interfaces (DAI), UARTs (universal asynchronous receiver transmitters), and user interface circuitry. The choice of digital processing hardware (and firmware/software, if included) depends on the design and performance specifications for a given desired implementation, and may vary from embodiment to embodiment.

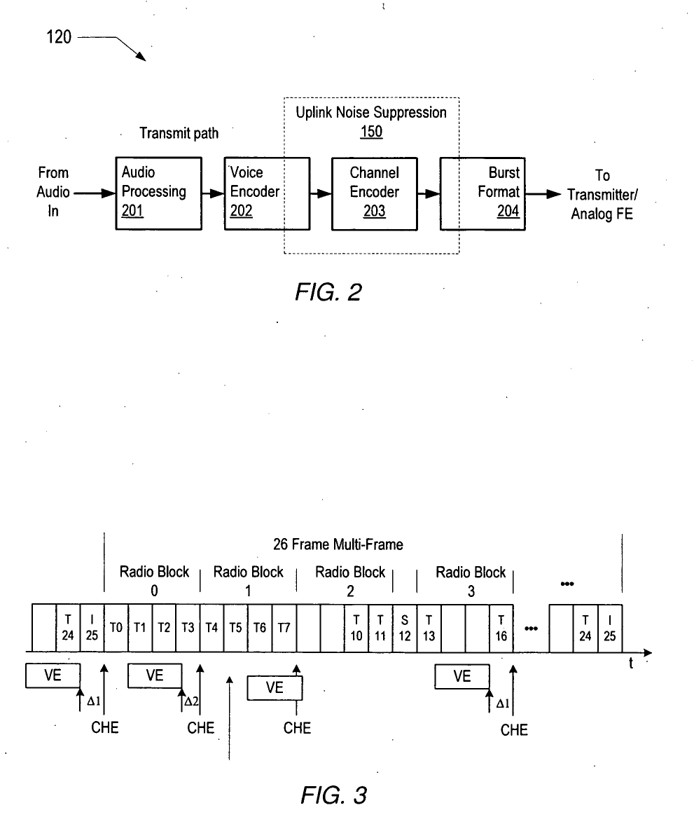

In the illustrated embodiment, digital processing circuit 120 includes an uplink noise suppression circuitry 150. As will be described in greater detail below, uplink noise suppression circuitry 150 may be implemented as part of various signal processing blocks such as voice encoder 202, channel coder 203, and burst format 204 of FIG. 2. As such, uplink noise suppression circuitry 150 may include logic to indicate the readiness status of voice payload data from the voice encoder to be read. In addition, in various embodiments uplink noise suppression circuitry 150 may include control logic and functionality to alter voice payload data, the corresponding error detecting/correcting code, and/or the burst format of speech frames such that receiver logic my detect the frames as bad frames. Existing receiver circuits in many mobile handsets may be capable of detecting bad frames. Accordingly, when a bad frame is detected at the receiver, such receiver circuits may replace the bad speech frame data with data that may correspond to comfort noise. Generally speaking, a bad frame or bad speech frame refers to a (speech) frame that, for a variety of reasons, may include a sufficient number of errors to render the frame unusable by the receiver.

Referring to FIG. 2, a block diagram illustrating specific aspects of one embodiment of the digital processing circuit of FIG. 1 is shown. Components that correspond to those shown in FIG. 1 are numbered identically for clarity and simplicity. Digital processing circuit 120 includes a transmit path having an audio processing block 201 coupled to a voice encoder 202, (also referred to as a speech encoder), which is in turn coupled to a channel encoder 203. Channel encoder 203 is further coupled to a burst format unit 204. As shown, portions of voice encoder 202, channel encoder 203, and burst format unit 204 may embody uplink noise suppression circuitry 150. It is noted that other components within digital processing circuit 120 are not shown for simplicity.

Referring collectively to FIG. 1 and FIG. 2, in one embodiment, analog audio signals may be received via antenna 130. The signals may be amplified, filtered and down converted to one or more intermediate frequencies before being converted to baseband. In one embodiment, the analog signals may be provided to audio processing block 201 where they may be converted into digital audio samples using an analog-to-digital conversion technique. In one embodiment, the digital audio samples may be formatted into pulse code modulation (PCM) digital audio samples and stored as four, 40-sample (e.g., 160 sample) signals. The digital audio samples may be buffered and then encoded by voice encoder 202. It is noted that digital voice samples having encodings other than PCM may be used in other embodiments, as desired.

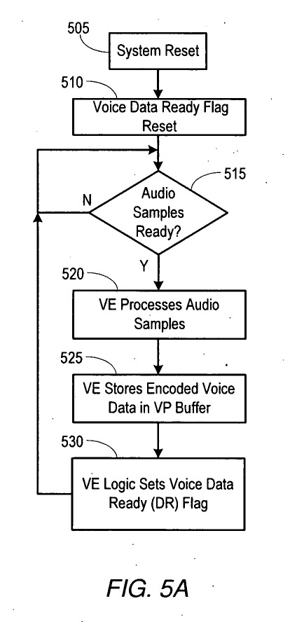

Voice encoder 202 may encode the PCM voice samples for later transmission on the air interface using one or more audio compression algorithms. Voice encoder logic may store the encoded voice data in a buffer (shown in FIG. 4) as voice payload data. In addition, as described further below, voice encoder 202 may include uplink noise suppression circuitry 150 that may provide an indication, such as a flag, for example, that may indicate whether the voice payload data is ready for further processing.

The voice payload data may subsequently be encoded by channel encoder 203. In one embodiment, channel encoder 203 may generate one or more error detection codes (EDC) based upon the voice payload data. The EDC may be appended to the voice payload data creating a larger channel-encoded data block. It is noted that the phrase error detection codes may be used when referring to both error detecting and error correcting codes. As such, the EDC may be generated using various methods, and may include convolutional codes, Hamming codes, cyclic redundancy codes (CRC), and the like. The channel-encoded voice data block may be provided to burst format unit 204 for further preparation for transmission. In various embodiments, burst formatting may include grouping the data block bits into separate burst groups, and appending training sequence bits, and/or other information bits to the new burst group bits. The burst-formatted data may be provided to the RF front end 110 for transmission via the air interface.

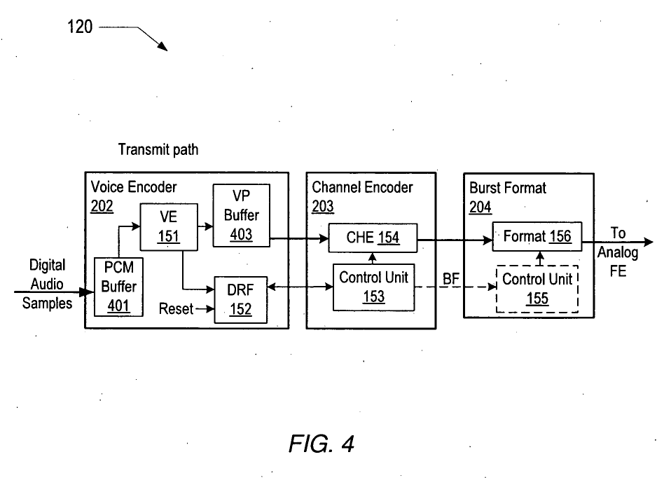

During normal operation, voice encoder 202 may complete encoding of the audio samples in enough time for the channel encoder to begin encoding the voice data. However, as described above and shown in FIG. 3, in certain situations, since the voice encoder and channel encoder may operate asynchronously with respect to each other, the voice encoder and the channel encoder may become out of sync such that the voice data payload may not be ready when the channel encoder starts reading the buffer used to store the voice payload data. As described above, this condition may allow bad voice data to be transmitted in the uplink and received undetected by a receiver. The received bad data may be heard as uncomfortable and unacceptable audio on the receiving end. To reduce the likelihood of bad voice data being received undetected, uplink noise suppression circuitry 150 may provide an indication to channel encoder 203 and/or burst format block 204 whether the encoded voice payload data is ready or not ready.

In addition, in one embodiment, uplink noise suppression circuitry 150 within channel encoder 203 may generate a predetermined encoding that may be detected by a receiver in response to receiving the indication. In an alternative embodiment, channel encoder 203 may provide a corresponding indication to the burst format block 204. In such an embodiment, the burst format unit 204 may generate an incorrectly formatted burst that may be detected as a bad frame by the receiver. In either embodiment, an indication may be provided to channel encoder 203, and/or to burst format block 204 that the voice payload data is not ready (i.e., bad data). Accordingly, channel encoder 203 may intentionally generate an invalid voice data block by mismatching the data and the EDC, or the burst format unit 204 may intentionally generate a bad frame that will be detected and interpreted to be bad data or a bad frame by a receiver. In this way, the receiver may inject comfort noise, or the like, in place of the bad data.

FIG. 3 is a timing diagram illustrating a typical multi-frame used in conjunction with the embodiments of FIG. 1 and FIG. 2. Generally speaking, in a GSM system that uses TDMA techniques, each frequency channel is subdivided into eight different time slots numbered from 0 to 7. Each of the eight time slots may be assigned to an individual user, while multiple slots can be assigned to one user in a GPRS/EDGE system. A set of eight time slots is typically referred to as a TDMA frame, and may have a duration of approximately 4.615 milliseconds (ms). A 26-multiframe is used as a traffic channel frame structure for the representative system. The total length of a 26-frame structure is therefore 26(4.615 ms)=120 ms. In a GSM system, a speech frame is 20 ms, however, a radio block is four TDMA frames, which is 4(4.615 ms)=18.46 ms. Thus, every three radio blocks the TDMA frame (or radio block boundary) and the speech frame boundaries are aligned.

Referring now to FIG. 3, the timing diagram illustrates an exemplary 26 multi-frame traffic channel structure. As shown, the 26 frames are numbered T0 through T11, S12, T13 through T24, and I25. In the illustrated embodiment, the frames correspond to TDMA frames as described above. Accordingly, the first 12 frames may be used to transmit traffic data such as voice payload data and these frames are designated T0-T11. The next frame may be used for transmitting slow associated control channel (SACCH) information, and is designated S12. The next 12 frames are also used to transmit traffic data and are designated T13-T24. The remaining frame is an idle frame and is. designated I25. It is noted that in some embodiments, the idle frame and the SACCH frame may be interchanged.

In the illustrated embodiment, frames T0-T3, T4-T7, T8-T11, etc. may comprise radio blocks 0, 1, 2, etc. At the end of each radio block, channel encoder 203 encodes the voice payload data, as denoted by the arrows labeled CHE. Prior to the CHE event, voice encoder 202 encodes the voice samples during the blocks labeled VE (VE blocks not to scale). As shown there is a time difference ‘Δ’ between the end of each voice encoding process and the start of each channel encoding process. As shown, Δ1 is larger than Δ2. Generally the Δ gets smaller for each successive radio block prior to the SACCH block (S12). After S12, the Δ may be reset as the VE and CHE processes may be resynchronized. The changing A may be due at least in part to the time allotted to the various processes. For example, as described above, the speech frame only aligns with the radio block boundary every third radio block.

During radio block 1, an example of a situation in which the synchronization between the VE and CHE process has been lost is shown. The synchronization may be lost during transient events such as a base station handover, a start of a call, and the like. In such events one or more frame lengths may be irregular, for example, thereby causing a loss of synchronization. Accordingly, as shown in the example, the VE process is not complete before the CHE process begins at the start of radio block 2. As a result, as described above, in the transmit path of a conventional wireless device, erroneous voice payload data may be encoded by the channel encoder and transmitted to a receiver. This voice data may be output to a user as uncomfortable noise. However, as described further below, uplink noise suppression circuitry 150 of wireless communication apparatus 100 may provide an indication to channel encoder 203 that the voice payload data is not ready.

Turning to FIG. 4, a block diagram illustrating more detailed aspects of the transmit path one embodiment of the digital processing circuit of FIG. 1 is shown. Components that correspond to those shown in FIG. 1 and FIG. 2 are numbered identically for clarity and simplicity. Accordingly, the transmit path of FIG. 4 is similar to the transmit path of FIG. 2, however the transmit path of FIG. 4 illustrates further details of uplink noise suppression circuitry 150. More particularly, voice encoder 202 includes a buffer, designated PCM buffer 401, to store digital audio samples provided by audio processing circuit 201, for example. Voice encoder 202 also includes an encoder module VE 151, that may be configured to compress the digital audio samples using one or more audio compression algorithms. Once the digital audio samples are encoded, the encoded data bits may be stored within VP buffer 403. VE 151 may also include uplink noise suppression logic to cause a data ready flag DRF 152 to indicate that voice encoding of the digital audio samples is complete and the voice payload data stored in VP buffer 403 is ready for further processing.

In one embodiment, DRF 152 may indicate the voice payload data is ready when the flag is set to a logic one, and the voice payload data is not ready when reset to a logic zero. Alternatively, DRF 152 may indicate the data is ready when the flag is set to a logic zero, and the data is not ready when reset to a logic one. DRF 152 may be realized using a variety of implementations. For example, DRF 152 may be a hardware register bit or bits, or DRF 152 may be implemented in software, as desired.

Channel encoder 203 includes a channel encoder module 154 that may be configured to generate error detection code (EDC) bits based upon the voice payload data. Channel encoder module 154 may append the EDC bits to one or more portions of the voice payload data (e.g., 260 bits) to create a larger data block having, for example, 456 bits. Channel encoder 203 also includes an encoder control unit 153 that may be configured to monitor the state of flag DRF 152. In addition, control unit 153 may be configured to cause channel encoder module 154 to modify the encoding in response to determining that the flag indicates the voice payload data is not ready. For example, in one embodiment, control unit 153 may cause channel encoder module 154 to generate an incorrect EDC for the voice payload data. Alternatively, control unit 153 may cause channel encoder module 154 to generate an EDC based on the received voice payload data, and then to modify the voice payload data when creating the 456-bit data block. In either case, on the receiving end, error-checking logic would detect the mismatch between the EDC bits and the data bits, and treat the frame as a bad frame.

In another embodiment, instead of control unit 153 causing channel encoder module 154 to generate a bad voice data block, control unit 153 may instead provide a bad frame (BF) notification to burst format unit 204 in response to receiving and/or determining that the flag (DRF 152) indicates the voice payload data is not ready. As such, channel encoder module 154 may generate EDC based upon the received voice payload data, and create a voice data block including the EDC and the voice payload data, even though the voice payload data may include bad data.

Burst format unit 204 includes a format module 156 that may be configured to format the 456-bit data block for transmission. For example in one embodiment, the 456-bit block may be broken up into 57-bit blocks. These blocks may be interleaved with blocks from another 20 ms speech sample prior to being sent to the RF front end 110 for transmission upon the air interface. In addition, in one embodiment, format module 156 may be configured to include a 26-bit training sequence in the middle of a burst to aid the receiver unit during the channel equalization task. Further, in one embodiment, burst format unit 204 includes a burst control unit 155 that may be configured to cause format module 156 to use an incorrect or invalid training sequence in response to receiving a BF notification from control unit 153. In such a case, a receiver that receives a burst having an incorrect or invalid training sequence may identify that frame as being a bad frame.

Accordingly, in the embodiments described above, the channel encoder 203 and/or burst format unit 204 may generate frames that may be detected as being bad frames (by a receiver), in response to a flag indicating that the voice payload data is not ready to be channel encoded at a time when the channel encoder begins encoding.

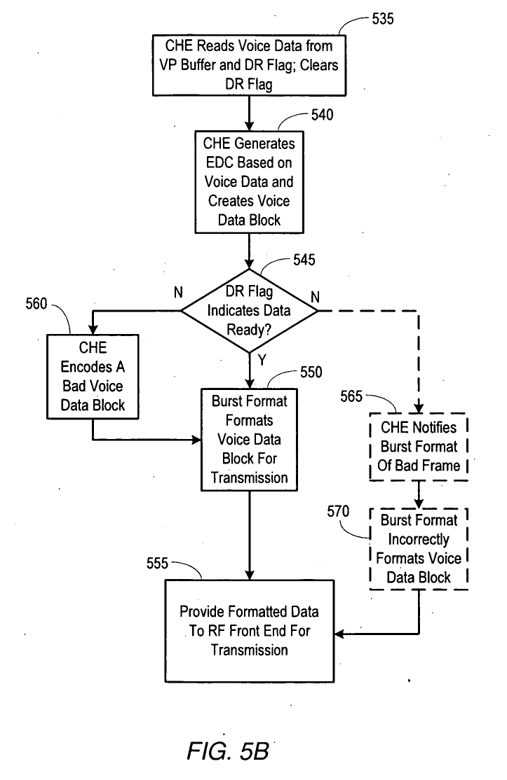

FIG. 5A and FIG. 5B are flow diagrams describing the operation of the embodiments shown in FIG. 1, FIG. 2 and FIG. 4. More particularly, FIG. 5A describes the operation of an embodiment of voice encoder 202, while FIG. 5B describes the operation of an embodiment of channel encoder 203. Referring collectively now to FIG. 1 through FIG. 5A, upon a system reset (block 505) or alternatively, in response to a clearing of the flag by control unit 153, voice data ready flag DRF 152 may be reset to indicate voice payload data is not ready (block 510). As described above, an analog audio signal may be down converted to a baseband signal and subsequently digitized into digital audio samples by audio processing block 201. The digital audio samples may be stored as a block in a buffer such as PCM buffer 401. If the audio samples are not ready, (block 515) voice encoder module 151 may wait until the block of audio samples are stored.

During a speech frame, voice encoder module 151 may process the block of audio samples from PCM buffer 401 (block 520). As described above the processing may include compressing the audio samples using one or more audio compression algorithms. When voice encoder module 151 is finished processing the block of audio samples associated with the current speech frame voice encoder module 151 may store the encoded data within VP buffer 403 (block 525). Voice encoder module 151 sets the flag DRF 152 to indicate the data in VP. buffer 403 is ready for channel encoding (block 530) and operation proceeds as described in block 515.

Turning to FIG. 5B, during normal operation, at the start of a new radio block, channel encoder module 154 reads the voice payload data from VP buffer 403. However, as described above, since operation of the channel encoder module 154 may be asynchronous with respect to the operation of voice encoder module 151, the reading of VP buffer 403 by channel encoder module 154 may occur at any time during processing of the speech frame.

As such, control unit 153 reads and subsequently clears the flag DRF 152 (block 535). In one embodiment, channel encoder module 154 may be configured to create a voice data block by generating EDC bits based upon the VP data using one or more EDC generation techniques as described above. Depending on the specific implementation, channel encoder module 154 may be configured to append the EDC bits to the VP data to create the voice data block (e.g., 456-bit block) (block 540).

If the flag DRF 152 indicates the VP data within VP buffer 403 is ready (block 545), channel encoder module 154 may be configured to provide the voice data block to format module 156 of burst format unit 204. As described above, format module 156 may be configured to prepare the data block for transmission by arranging the data block into a number of smaller data blocks and to add a training sequence (block 550). When burst formatting is complete, the formatted data may be provided to the RF front end 110 for transmission (block 555). Operation may proceed as described above in block 515 of FIG. 5A.

Referring back to block 545, if the flag DRF 152 indicates the VP data within VP buffer 403 is/was not ready, in one embodiment, channel encoder module 154 may be configured to intentionally encode a bad voice data block. In one implementation, channel encoder module 154 may modify the previously created voice data block by modifying the EDC bits such that they do not match the VP data (e.g., one or more EDC bits may be flipped or complemented). Accordingly, the voice data block and consequently, the speech frame may be detected as a bad frame by a receiver. In another implementation, instead of modifying the EDC bits, channel encoder module 154 may be configured to modify the previously created voice data block by modifying any number of bits of the VP data (or the channel-encoded VP data) (e.g., one or more data bits may be flipped or complemented) such that the VP data does not match the EDC. Again, the voice data block and consequently, the speech frame may be detected as a bad frame by a receiver. Operation may proceed as described above in block 550.

It is contemplated that in contrast to creating a voice data block, and subsequently checking the flag DRF 152, in other embodiments, the flag DRF 152 may be checked prior to creation of the voice data block by channel encoder module 154. In such embodiments, in response to the flag indicating the data is not ready the channel encoder 154 may be configured to encode a bad voice data block on-the-fly by either generating bad (non-matching) EDC bits, or modifying the VP data (or encoded VP data) such that it doesn't match the EDC.

In an alternative embodiment (as denoted by the dashed lines), if the flag DRF 152 indicates the VP data within VP buffer 403 is not ready (block 545), channel encoder module 154 may be configured to provide the previously created voice data block to format module 156. However, control unit 153 may provide a bad frame indication (BF) to control unit 155 of burst format unit 204 (block 565). Accordingly, when format module 156 receives the voice data block from channel encoder 203, control unit 155 may cause format module 156 to create a bad voice data block (block 570). For example, in one embodiment, format module 156 may generate a bad or invalid training sequence that may cause a receiver to identify the speech frame as a bad frame. Operation may proceed as described above in block 555.

It is noted that the various components described above may be implemented using hardware circuits, software, or a combination of hardware and software as desired.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A wireless communication apparatus comprising:
a voice encoder configured to encode a number of digital audio samples into voice payload data using one or more audio compression algorithms;
uplink suppression logic coupled to the voice encoder and configured to provide an indication of whether the voice payload data is ready for further processing; and
wherein the uplink suppression logic is further configured to cause one or more bad voice data blocks to be generated for transmission in response to the indication indicating that the voice payload data is not ready for further processing.

2. The wireless communication apparatus as recited in claim 1, further comprising a channel encoder coupled to the voice encoder and configured to generate an error detection code based upon to the voice payload data, and to create a voice data block including the voice payload data and the error detection code.

3. The-wireless communication apparatus as recited in claim 2, wherein in response to receiving the indication that the voice payload data is ready for further processing, the channel encoder is further configured to provide the voice data block to a burst format unit for further processing.

4. The wireless communication apparatus as recited in claim 2, further comprising an encoder control unit coupled to the channel encoder and configured to cause the channel encoder to modify the voice data block by modifying one or more bits of the error detection code such that the error detection code does not match the voice payload data in response to the indication that the voice payload data is not ready for further processing.

5. The wireless communication apparatus as recited in claim 2, further comprising an encoder control unit coupled to the channel encoder and configured to cause the channel encoder to modify the voice data block by modifying one or more bits of the voice payload data such that the voice payload data does not match the error detection code in response to the indication that the voice payload data is not ready for further processing.

6. The wireless communication apparatus as recited in claim 1, wherein the indication is a flag that when set, indicates that the voice payload data is ready to be read, and that when clear indicates that the voice payload data is not ready for further processing.

7. The wireless communication apparatus as recited in claim 2, further comprising an encoder control unit coupled to the channel encoder and configured to provide a bad frame indication in response to the indication that the voice payload data is not ready for further processing.

8. The wireless communication apparatus as recited in claim 6, further comprising a burst format unit coupled to a burst control unit and to the channel encoder, wherein the burst control unit is configured to cause the burst format unit to format the voice data block using an invalid training pattern in response to receiving the bad frame indication.

9. The wireless communication apparatus as recited in claim 1I further comprising a channel encoder configured to generate a bad voice data block by generating an error detection code that does not match the voice payload data in response to the indication that the voice payload data is not ready for further processing.

10. A method comprising:
encoding a number of digital audio samples into voice payload data using one or more audio compression algorithms;
providing an indication of whether the voice payload data is ready for further processing; and
in response to receiving the indication that the voice payload data is not ready for further processing, generating one or more bad voice data blocks for transmission.

11. The method as recited in claim 10, further comprising generating an error detection code based upon to the voice payload data, and creating a voice data block including the voice payload data and the error detection code.

12. The method as recited in claim 11, further comprising, in response to receiving the indication that the voice payload data is ready for further processing, providing the voice data block to a burst format unit for further processing.

13. The method as recited in claim 11, further comprising, in response to the indication that the voice payload data is not ready for further processing, modifying the voice data block by modifying one or more bits of the error detection code such that the error detection code does not match the voice payload data.

14. The method as recited in claim 11, further comprising, in response to the indication that the voice payload data is not ready for further processing, modifying the voice data block by modifying one or more bits of the voice payload data such that the voice payload data does not match the error detection code.

15. The method as recited in claim 10, wherein the indication is a flag that when set, is indicative that the voice payload data is ready for further processing, and that when clear is indicative that the voice payload data is not ready for further processing.

16. The method as recited in claim 1 1, further comprising formatting the voice data block using an invalid training pattern in response to receiving the bad frame indication.

17. The method as recited in claim 16, further comprising, generating an error detection code that does not match the voice payload data in response to the indication that the voice payload data is not ready for further processing.

18. A wireless telephone comprising:
an analog circuit configured to transmit and receive audio signals;
a digital circuit coupled to the analog circuit and configured to generate and process digital signals corresponding to the audio signals;
wherein the digital circuit includes:
a voice encoder configured to encode a number of digital audio samples into voice payload data using one or more audio compression algorithms;
uplink suppression logic coupled to the voice encoder and configured to provide an indication of whether the voice payload data is ready for further processing; and
wherein the uplink suppression logic is further configured to cause one or more bad voice data blocks to be generated for transmission in response to the indication indicating that the voice payload data is not ready for further processing.

18. The wireless telephone as recited in claim 17, wherein the digital circuit further comprises a channel encoder coupled to the voice encoder, wherein the channel encoder is configured to generate an error detection code based upon to the voice payload data, and to create a voice data block including the voice payload data and the error detection code.

19. The wireless telephone as recited in claim 18, wherein the channel encoder is further configured to provide the voice data block to a burst format unit for further processing in response to receiving the indication that the voice payload data is ready for further processing.

20. The wireless telephone apparatus as recited in claim 18, wherein the digital circuit further comprises an encoder control unit coupled to the channel encoder, wherein the encoder control unit is configured to cause the channel encoder to modify the voice data block by modifying one or more bits of the error detection code such that the error detection code does not match the voice payload data in response to the indication that the voice payload data is not ready for further processing.
